(19) United States
(12) Patent Application Publication
(10) Pub. No.: US 2008/0166302 A1
(43) Pub. Date: Jul. 10, 2008

(54) Substance Emitting Product

(75) Inventor: Tan Soon Cheng, Petaling Jaya (MY)

Correspondence Address: BIRCH STEWART KOLASCH & BIRCH, PO BOX 747, FALLS CHURCH, VA, 22040-0747, US

(73) Assignees: Tan Soon Cheng Sdn. Bhd., Petaling Jaya , Selangor Darul Ehsan (MY); Tan Huat Ben, Singapore (SG)

(21) Appl. No.: 11/884,788

(22) PCT Filed: Apr. 13, 2006
(86) PCT No.: PCT/SG2006/000098

§ 371 Date: Nov. 20, 2007

(30) Foreign Application Priority Data
Apr. 18, 2005 (MY) PI 2005 1717

(51) Int. Cl. A01N 25/20; A01P 17/00

(52) U.S. Cl. 424/40

(57) ABSTRACT

The present invention relates to a substance emitting product comprising a combustible structural element incorporated with a pesticide and/or fragrance wherein the combustible structural element is a coil shaped cardboard strip characterized in that the combustible structural element is a made from palm fibres. The palm fibres are obtained from oil palm empty fruit bunches and/or oil palm mesocarp. The combustible structural element is made from up to 90-99.5 wt % of the palm fibres with other minor ingredients, selected from the group comprising fillers, combustion regulators, dyes and fungicide or a mixture thereof, making up the balance. The combustible structural element has a density ranging from 400-1000 kgm−³, preferably ranging from 600-750 kgm⁻³.

### FIELD OF THE INVENTION

This invention relates to a substance emitting product commonly known as mosquito coil when the emitted substance on combustion is pesticide, or known as incense when the emitted substance on combustion is a fragrance. More particularly, this invention relates to a substance emitting product made by using palm fibre.

### BACKGROUND OF THE INVENTION

A substance emitting product is normally made of a combustible structural element incorporated with a pesticide and/or fragrance. The combustible structural element is formed by using wood material, such as wood powder, coconut shell powder or a mixture thereof and a binder. The source of wood material is often inconsistent. As a result the quality of the substance emitting product is often difficult to be controlled for uniformity or consistency. Increasingly tightened control of logging activities in many countries also causes shortage in supply of wood for production of wood powder. The conventional type of substance emitting product is brittle, therefore it is susceptible to breakage during production or when being transported, packed or used. Moreover, this type of substance emitting product may warp during production to assume a wavy or convex conformation instead of a planar form. Wavy or warped substance emitting product is not preferred by consumers.

U.S. Pat. No. 5,447,713 discloses a mosquito coil consisting essentially of a spiral punched out from a board consisting of wood chips and/or wood-fibre material, the density of the spiral ranging from 0.4-0.7 kgdm⁻³, and a coating on the spiral consisting essentially of an active substance toxic to mosquitoes.

European patent application number 1,164,843 discloses a substance delivery device comprising a combustible paperboard strip and at least one of a substance toxic to insects and a perfume.

United Kingdom patent number 2,368,797 discloses a combustible pesticidal product which comprises a structural element formed from a cardboard having a thickness of at least 0.75 mm, a density of 450-850 kgm⁻³ and consisting of one or more plies wherein the product on combustion emanates a pesticide into the atmosphere.

Cardboard-based substance emitting products disclosed above are resistant to breakage but as they are normally made from recycled paper, a large amount of impurities, such as chemicals and paints, present in recycled paper would cause the substance emitting products to release an obnoxious smell or even toxic vapour on combustion.

Hence, there is a need for substance emitting product which exhibits high level of structural integrity and consistency and effective in emitting the desired substance while not releasing any obnoxious smell on combustion.

### SUMMARY OF THE INVENTION

The present invention relates to a substance emitting product comprising a combustible structural element incorporated with a pesticide and/or fragrance wherein the combustible structural element is a coil shaped cardboard strip characterized in that the combustible structural element is made from palm fibres. The palm fibres are obtained from oil palm empty fruit bunches and/or oil palm mesocarp.

The combustible structural element is made from up to 90-99.5 wt % of the palm fibres with other one minor ingredients, selected from group comprising fillers, combustion regulators, dyes and fungicide or a mixture thereof, making up the balance. The combustible structural element has a density Ranging from 400-1000 kgm⁻³, preferably ranging from 600-750 kgm⁻³. Where the coil shaped cardboard strip is made from laminated cardboard, the pesticide and/or fragrance can be incorporated into a binder formulation used for laminating paper sheets to form the laminated cardboard.

### DETAILED DESCRIPTION OF THE INVENTION

The present invention relates to a substance emitting product comprising a combustible structural element incorporated with a pesticide and/or fragrance. The substance emitting product emits the pesticide and/or fragrance on combustion and the emission rate of pesticide and/or fragrance is dependant on the combustion rate of the substance emitting product.

Palm fibre is the main ingredient of the combustible structural element. Other minor ingredients that can be added to the combustible structural element are: fillers such as clay, wood powder and coconut shell powder; combustion regulators including flame inhibitors such as calcium carbonate (CaCO₃); flame promoters such as carbon/charcoal powder and potassium nitrate (KNO₃); dyes and fungicide. Palm fibre makes up to 90-99.5 wt % of the combustible structural element with other minor ingredients making up the balance.

The palm fibre is obtained from oil palm empty fruit bunches (EFB), substantially deoiled oil palm mesocarp or a mixture thereof, particularly from EFB. Residual oil content of the palm fibre must be substantially low, preferably not exceeding 0.1 weight percent (wt %).

The combustion rate of the substance emitting product is controlled by the density of the combustible structural element and/or by varying the amount and/or the type of combustion regulator added to the combustible structural element. When the density of the combustible structural element is high, the combustion rate of the substance emitting product might be too low; flame promoter can be added to increase its combustion rate. On the other hand, when the density of the combustible structural element is low, the combustion rate of the substance emitting product might be too high; flame inhibitor can be added to slow down its combustion rate.

The substance emitting product is produced by the following steps:
a) extracting palm fibres from EFB and/or de-oiled oil palm mesocarp;
b) forming cardboard from the extracted palm fibres;
c) cutting the cardboard into desired shape and size to form the combustible structural element; and
d) incorporating a pesticide and/or fragrance to the combustible structural element;
   wherein the pesticide and/or fragrance can be incorporated to the combustible structural element in the cardboard forming stage, after the cardboard has-been formed and/or after the cardboard has been cut to form the combustible structural element.

Various embodiments for the present invention are shown as examples.

### EXAMPLE 1

### Exracting Palm Fibres from EFB

Palm fibres are extracted by the following steps:
i) removing impurities and foreign materials from EFB;
ii) digesting the EFB under pressure
iii) feeding the digesting EFB to a refiner in which the digested EFB is crushed and grinded;
iv) obtaining the resultant palm fibre pulp from the refiner.

If the impurities content of EFB is low, the impurities can be physically removed by workers but if the impurities content of EFB is high, equipment for example a vibrator is required to remove the impurities.

The EFB is digested under high pressure and high temperature, normally at a pressure of 600-700 kPa (6-7 bars) and a temperature of 120-130° C. If the moisture content of EFB is more than 50 wt %, the EFB can be digested without adding water to it but if the moisture content of EFB is less than 50 wt %, water is added to the EFB prior to being digested.

The resultant palm fibre pulp from the refiner typically has a freeness of approximately 700 CSF (Canadian Standard Freeness). If a higher freeness for the palm fibre pulp is desired, the resultant palm fibre pulp can be further refined.

EFB and de-oiled oil palm mesocarp are waste materials from oil palm mills. As oil palm mill is the source of EFB and de-oiled oil palm mesocarp, palm fibres extraction process is suitable to be conducted in the oil palm mill. Then, the palm fibre pulp has to be transported to a paper and/or cardboard making plant for further processing into the substance emitting product. For ease of transportation, the palm fibre pulp is dried and bagged prior to being transported.

In case that palm fibres extraction process and further processing steps are to be conducted in the same plant, then the palm fibre pulp can be used directly for further processing steps.

Teachings of UK patent GB 1,110,053 can be applied herewith for extracting palm fibres from EFB.

### EXAMPLE 2

### Forming Cardboard from Palm Fibres

Palm fibre pulp from Example I is used for forming cardboard. The cardboard forming process comprises the following steps:
i) homogenizing the palm fibre pulp;
ii) refining the homogenized palm fibre pulp;
iii) mixing the refined palm fibre pulp with minor ingredients, particularly water insoluble minor ingredients such as fillers and CaCo₃;
iv) spreading a thick layer of the resultant palm fibre pulp onto a wire roller surface and much water is drained from the palm fibre pulp resulting in a newly formed cardboard sheet;
v) pressing the newly formed cardboard sheet to squeeze out much of the remaining water;
vi) drying the pressed cardboard sheet.

The above-mentioned cardboard forming process is known as a calendaring process. Another cardboard forming process which is known as laminating process involves using the above-mentioned steps for forming paper sheet before laminating several layers of paper sheets into a cardboard sheet. The difference between forming paper sheet and forming cardboard sheet using the above-mentioned steps lies in step (iv). If paper sheet is to be formed, a thin layer of palm fibre pulp should be spread instead of a thick layer.

In case that the palm fibre pulp used is in dried form, then the dried palm fibre should be hydrated to a pulp form before starting the above-mentioned steps.

### EXAMPLE 3

### Forming Combustible Structural Element from Cardboard

The cardboard sheet from Example 2 is die cut into cardboard strips in coil shape, particularly in square coil shape, forming the combustible structural element. The combustible structural element should be able to sustain smooth combustion for at least 6 hours; therefore the cardboard used for forming the combustible structural element should have a density ranging from 400-1000 kgm⁻³, preferably 600-750 kgm⁻³. Combustion time of the combustible structural element could be altered by adding flame inhibitor to it when its combustion time is too short and by adding flame promoter to it when its combustion time is too long or when it has difficulty in sustaining smooth combustion.

### EXAMPLE 4

### Incorporating Pesticide and/or Fragrance and Other Minor Ingredients to the Combustible Structural Element

Pesticide and/or fragrance and other minor ingredients could be incorporated to the combustible structural element at various stages:
Cardboard forming process
   Referring to Example 2, the pesticide and/or fragrance and other minor ingredients can be added during step (iii). Major drawbacks of this method are waste chemical solution handling problem and difficulty in controlling concentration of chemical solution. Alternatively, the pesticide and/or fragrance and other minor ingredients can be sprayed or applied on the paper sheets before laminating them to form a cardboard. The pesticide and/or fragrance and other minor ingredients can also be added to a binder formulation used for laminating the paper sheets to form cardboard.
After the cardboard has been formed and/or after the cardboard has been cut to form the combustible structural element
   The pesticide and/or fragrance and other minor ingredients can be sprayed or applied on the cardboard sheet or the combustible structural element.

Generally, water insoluble minor ingredients are suitable to be incorporated during step (iii) of Example 2 but they can be added at a later stage as mentioned above whereby a suspension of the water insoluble minor ingredients is used. Water or solvent soluble minor ingredients, pesticide and/or fragrance are more suitable to be incorporated after step (iii) of Example 2 in one of the stages as mentioned above.

1) A substance emitting product comprising a combustible structural element incorporated with a pesticide and/or fragrance wherein the combustible structural element is a coil shaped cardboard strip characterized in that the combustible structural element is made from palm fibres.

2) A substance emitting product as claimed in claim 1 wherein the palm fibres are obtained from oil palm empty fruit bunches and/or oil palm mesocarp.

3) A substance emitting product as claimed in claims 1 and 2 wherein the combustible structural element is made from up to 90-99.5 wt % of the palm fibres with other minor ingredients, selected from the group comprising fillers, combustion regulators, dyes and fungicide or a mixture thereof, making up the balance.

4) A substance emitting product as claimed in claim 1 wherein the combustible structural element has a density ranging from 400-1000 kgm⁻³.

5) A substance emitting product as claimed in claim 1 wherein the combustible structural element has a density ranging from 600-750 kgm⁻³.

6) A substance emitting product as claimed in claim 1 wherein the coil shaped cardboard strip is made from laminated cardboard and wherein the pesticide and/or fragrance is incorporated into a binder formulation used for laminating paper sheets to form the laminated cardboard.

7) A substance emitting product comprising a combustible structural element incorporated with a pesticide and/or fragrance wherein the combustible structural element is a coil shaped cardboard strip characterized in that the combustible structural element includes
i) up to 90-99.5 wt % of palm fibres obtained from oil palm empty fruit bunches and/or oil palm mesocarp;
ii) at least 0.5-10 wt % of other minor ingredients selected from the group comprising fillers, combustion regulators, dyes and fungicide or a mixture thereof; and
wherein the combustible structural element has a density ranging from 600-750 kgm⁻³

8) A substance emitting product as claimed in claim 7 wherein the coil shaped cardboard strip is made from laminated cardboard and wherein the pesticide and/or fragrance is incorporated into a binder formulation used for laminating paper sheets to form the laminated cardboard.

9) A mosquito coil made from palm fibres.

10) A mosquito coil consisting of a coil shaped cardboard strip, which is made from palm fibres, incorporated with a pesticide and/or fragrance.

11) A mosquito coil as claimed in claims 9 and 10 wherein the palm fibres are obtained from oil palm empty fruit bunches and/or oil palm mesocarp.

12) A mosquito coil as claimed in claim 9 wherein the mosquito coil is made from up to 90-99.5 wt % of the palm fibres with other minor ingredients, selected from the group comprising fillers, combustion regulators, dyes and fungicide or a mixture thereof, making up the balance.

13) A mosquito coil as claimed in claim 9 wherein the mosquito coil has a density ranging from 400-1000 kgm⁻³.

14) A mosquito coil as claimed in claim 9 wherein the mosquito coil has a density ranging from 600-750 kgm⁻³.

15) A mosquito coil as claimed in claim 10 wherein the coil shaped cardboard strip is made from laminated cardboard and wherein the pesticide and/or fragrance is incorporated into a binder formulation used for laminating paper sheets to form the laminated cardboard.

16) A mosquito coil consisting of a coil shaped cardboard strip incorporated with a pesticide and/or fragrance characterized in that the coil shaped cardboard strip includes
i) up to 90-99.5 wt % of palm fibres obtained from oil palm empty fruit bunches and/or oil palm mesocarp;
ii) at least 0.5-10 wt % of other minor ingredients selected from the group comprising fillers, combustion regulators, dyes and fungicide or a mixture thereof; and
wherein the coil shaped cardboard strip has a density ranging from 600-750 kgm⁻³.

17. A mosquito coil as claimed in claim 16 wherein the coil shaped cardboard strip is made from laminated cardboard and wherein the pesticide and/or fragrance is incorporated into a binder formulation used for laminating paper sheets to form the laminated cardboard.
